(19) United States
(12) Patent Application Publication
(10) Pub. No.: US 2010/0308485 A1
(43) Pub. Date: Dec. 9, 2010

(54) PATTERN FORMING APPARATUS AND PATTERN FORMING METHOD

(76) Inventors: Ryoichi INANAMI, Yokohama-Shi (JP); Syunji Araki, Kawasaki-Shi (JP); Takuya Kono, Yokosuka-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/728,527

(22) Filed: Mar. 22, 2010

(30) Foreign Application Priority Data
Jun. 5, 2009 (JP) 2009-136218

(51) Int. Cl. B29C 59/02

(52) U.S. Cl. 264/40.1; 425/150

(57) ABSTRACT

A pattern is formed by an imprint technique, without decreases in throughput and alignment precision. A pattern forming apparatus includes a substrate holder that holds a substrate to be processed, a template holder that holds a template, a first position measuring device that measures the position of the substrate held by the substrate holder, a second position measuring device that measures the position of the template held by the template holder, and a control device that aligns the substrate with the template, based on transfer position information, calculates misalignments of the substrate and the template caused by a demolding procedure, based on the results of the measurement carried out by the first position measuring device and the second position measuring device, calculates a relative misalignment between the substrate and the template, based on the misalignments of the substrate and the template, and corrects the transfer position information, using the relative misalignment.

### CROSS-REFERENCE TO RELATED APPLICATION

This application is based upon and claims the benefit of priority from prior Japanese Patent Application No. 2009-136218, filed on Jun. 5, 2009, the entire contents of which are incorporated by reference.

### BACKGROUND OF THE INVENTION

1. Field of the Invention

The present invention relates to a pattern forming apparatus and a pattern forming method, and more particularly, to a pattern forming apparatus and a pattern forming method for forming minute patterns of semiconductor devices by an imprint technique.

2. Background Art

In recent years, imprint lithography techniques have been actively studied and developed as leading techniques for semiconductor miniaturization.

Imprint lithography involves a template (also called an imprint mask, a mold, or a stamper) that has a predetermined concave-convex pattern formed on its surface and is made of quartz or the like.

Known examples of imprint lithography techniques include a thermal imprint technique using a thermoplastic resist as a resist material, and an optical imprint technique using a light-curing resist as a resist material that is solidified when irradiated with ultraviolet (UV) light.

The procedures for forming a pattern by the optical imprint technique are roughly as follows.

First, a light-curing resist material is applied to a predetermined pattern transfer region on a substrate to be processed (a wafer) (an application procedure).

Alignment is then performed between the substrate to be processed and a template, so that the pattern transfer region comes immediately below the template (an alignment procedure).

The template is brought into contact with the resist material. After the resist material permeates the concave-convex pattern of the template, UV light are emitted to solidify the resist material. In this manner, the concave-convex pattern of the template is transferred onto the resist material (a pattern transfer procedure).

The template is then lifted up and is detached from the solidified resist material (a demolding procedure).

Through the series of procedures (hereinafter referred to as an imprint process), a resist pattern having a reverse pattern of the concave-convex pattern formed on the template is formed. This imprint process is repeated to form the resist pattern on the entire substrate to be processed. A remaining film removing procedure is then carried out to remove the remaining films of the resist material. After that, with the resist pattern serving as a mask, etching is performed on the substrate to be processed. In this manner, a desired pattern is obtained.

As described above, by the imprint lithography, the imprint process is repeated for an entire wafer. Therefore, the processing time tends to be long, and the throughput tends to be low.

The alignment procedure in each imprint process requires a relatively long time, for high-precision alignment is performed by detecting the position of a mark pattern (also called an alignment mark). Therefore, minimizing the time required for the alignment procedure is essential in increasing the total throughput of the imprint processes.

Meanwhile, as alignment methods, the die-by-die method and the global alignment method have been widely known (see Japanese Patent Application Laid-open Nos. 1996-097114 and 2002-110507, for example).

According to the die-by-die method, in the alignment procedure of each imprint process, the position of a mark pattern formed on the base pattern of the substrate to be processed and the position of a mark pattern formed on the template are detected, and alignment is performed by checking the overlapping between those mark patterns. In this case, the time required for the alignment procedure becomes longer, and the throughput becomes much lower.

According to the global alignment method, prior to the first imprint process, the positions of some (the mark patterns at the four corners, for example) of the mark patterns formed on the wafer are measured in advance. Based on the results of the measurement, the positions of the other mark patterns, which are the positions on the wafer to which the concave-convex pattern of the template is to be transferred (hereinafter referred to as the shot positions), are calculated. In this case, the positions of the mark patterns are not detected in the alignment procedure of each imprint process, though those positions are detected in the case of the die-by-die method. Instead, alignment is performed between the wafer and the template, based on the calculated position information about the mark patterns. Accordingly, the time required for the alignment procedures can be greatly shortened.

### SUMMARY OF THE INVENTION

According to a first aspect of the present invention, a pattern forming apparatus that forms a pattern by an imprint technique includes: a substrate holder that is configured to be capable of holding a substrate to be processed; a template holder that is configured to be capable of holding a template that has a pattern face, a predetermined pattern being formed on the pattern face; a first position measuring device that measures a position of the substrate to be processed held by the template holder; a second position measuring device that measures a position of the template held by the template holder; and a control device that aligns the substrate to be processed and the template with each other, based on transfer position information indicating a position on the substrate to be processed, the predetermined pattern being transferred to the position, calculates a misalignment of the substrate to be processed caused by a demolding procedure, based on a result of the measurement carried out by the first position measuring device, the demolding procedure being carried out to detach the template from a solidified resist material on the substrate to be processed, calculates a misalignment of the template caused by the demolding procedure, based on a result of the measurement carried out by the second position measuring device, calculates a relative misalignment between the substrate to be processed and the template, based on the misalignment of the substrate to be processed and the misalignment of the template, and corrects the transfer position information, using the relative misalignment.

According to a second aspect of the present invention, a pattern forming apparatus that forms a pattern by an imprint technique includes: a substrate holder that is configured to be capable of holding a substrate to be processed; a template holder that is configured to be capable of holding a template that has a pattern face, a predetermined pattern being formed on the pattern face; a position measuring device that measures a position of the substrate to be processed held by the template holder, or the position of the template held by the template holder; and a control device that aligns the substrate to be processed and the template with each other, based on transfer position information indicating a position on the substrate to be processed, the predetermined pattern being transferred to the position, calculates a misalignment of the substrate to be processed or the template caused by a demolding procedure, based on a result of the measurement carried out by the position measuring device, the demolding procedure being carried out to detach the template from a solidified resist material on the substrate to be processed, and corrects the transfer position information, using the misalignment as a relative misalignment between the substrate to be processed and the template.

According to a third aspect of the present invention, a pattern forming method for forming a pattern by an imprint technique includes: holding a substrate to be processed in a reference position on a substrate holder; holding a template in a reference position on a template holder, the template having a pattern face, a predetermined pattern being formed on the pattern face; obtaining transfer position information indicating a position on the substrate to be processed, the predetermined pattern being transferred to the position; applying or dropping a resist material onto the substrate to be processed; aligning the substrate to be processed and the template with each other, based on the transfer position information; solidifying the resist material after the template is brought into contact with the resist material and grooves of the predetermined pattern on the template are filled with the resist material; carrying out a demolding procedure to detach the template from the solidified resist material on the substrate to be processed; measuring the position of the substrate to be processed and the position of the template after the demolding procedure, and calculating a misalignment of the substrate to be processed and a misalignment of the template, based on the results of the measurement, the misalignments being caused by the demolding procedure; calculating a relative misalignment between the substrate to be processed and the template, based on the misalignment of the substrate to be processed and the misalignment of the template; and correcting the transfer position information, using the relative misalignment.

### BRIEF DESCRIPTION OF THE DRAWINGS

FIG. 1 is a schematic view illustrating the structure of a pattern forming apparatus according to a first embodiment of the present invention;

FIG. 2 is a flowchart illustrating a pattern forming method according to the first embodiment of the present invention;

FIG. 3 is a flowchart illustrating the pattern forming method according to the first embodiment of the present invention, continuing from the flowchart in FIG. 2;

FIG. 4 is a drawing for describing a specific example of the information stored in the storages; and

FIG. 5 is a schematic view illustrating the structure of a pattern forming apparatus according to a modification of the first embodiment of the present invention.

### DESCRIPTION OF THE EMBODIMENTS

First, the background to the development of the invention by the inventors will be described before description of embodiments of the present invention.

As described above, according to the global alignment method, the throughput can be greatly increased. However, the inventors discovered that the following problems inherent to imprint techniques are caused where the global alignment method is applied to imprint techniques.

In the demolding procedure to detach the template from the solidified resist material, a very large force (a demolding force) acts between the resist material and the template. More specifically, a very large force is required for demolding, and in practice, the template is more like “being torn off” from the resist material.

The reason for the action of such a large demolding force is now described. A very minute concave-convex pattern of a nanometer order is formed over a pattern transfer region of a millimeter order on the surface of the template. Therefore, the contact area between the template and the resist material is very large, and the demolding force becomes also very large.

The template and the wafer are secured to reference positions on a template holder and a substrate holder by fixing means such as vacuum chucks. During the demolding procedure, however, the template and the wafer might deviate from the reference positions due to the large demolding force. In such a case, the shot positions calculated based on the reference positions prior to the imprint processes become meaningless. As a result, the alignment precision of the global alignment method that is normally effective to increase the throughput becomes lower.

As described above, in conventional imprint processes, the template and the wafer might deviate from the reference positions during the demolding procedure. Therefore, the global alignment method cannot be utilized, and the throughput remains at a low level.

The present invention has been made in view of the above circumstances, and provides a pattern forming apparatus and a pattern forming method that can prevent degradation of the pattern transfer precision due to misalignments of the template and the substrate, and increase the throughput by imprint lithography.

Hereafter, embodiments according to the present invention will be described with reference to the drawings.

The components having the same functions are denoted by the same reference numeral, and detailed description of them will not be repeated herein.

### First Embodiment

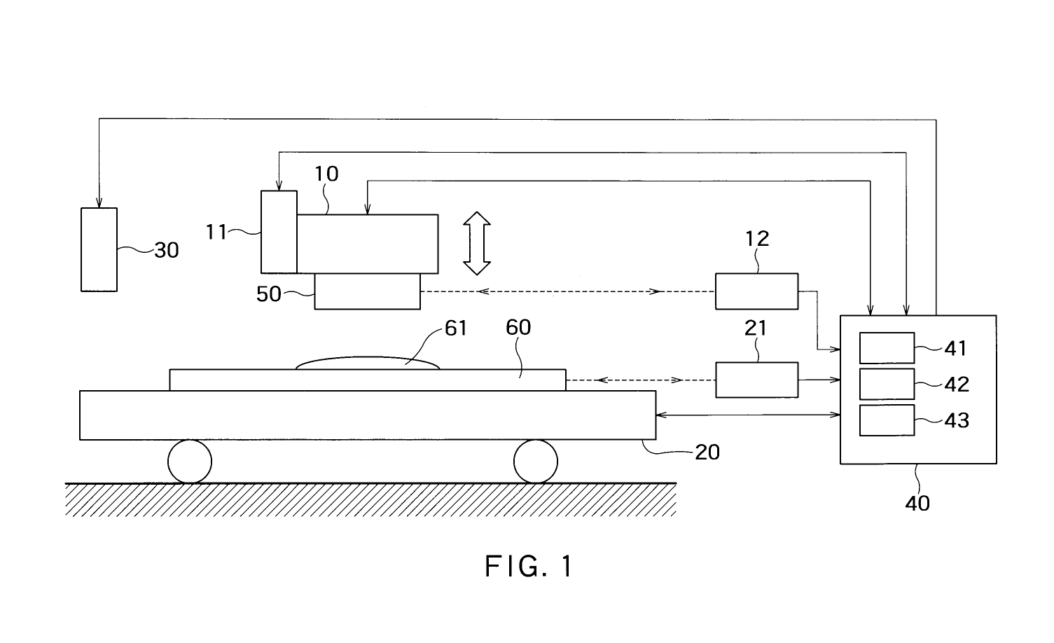

FIG. 1 schematically illustrates the structure of a pattern forming apparatus according to a first embodiment of the present invention.

As can be seen from FIG. 1, the pattern forming apparatus according to this embodiment includes a template holder 10, an alignment measuring device 11, a template position measuring device 12, a substrate holder 20, a wafer position measuring device 21, a resist applying device 30, and a control device 40. The pattern forming apparatus according to this embodiment may further include a source of UV light for solidifying a resist material.

Each of the components of the pattern forming apparatus according to this embodiment will now be described.

The template holder 10 is designed to hold a template 50 in a reference position on the template holder 10 with a vacuum chuck, for example. The template 50 has a pattern face having a predetermined concave-convex pattern formed thereon.

The template holder 10 has a moving mechanism (not illustrated) that moves the template 50 in the vertical direction (the z-direction). With this arrangement, the template holder 10 can move the template 50 up and down in the pattern transfer procedure and a demolding procedure. With the template 50 moving up and down, the upper position where the template stops is referred to as the upper resting position, and the lower position where the template stops is referred to as the lower resting position.

The alignment measuring unit 11 measures the position of a predetermined mark pattern formed on a wafer (a substrate to be processed) 60. The measurement result is sent to the control device 40 (described later).

The template position measuring device 12 measures the position of the template 50 held by the template holder 10. The template position measuring device 12 is formed with a position detector such as an interferometer or an encoder (a rotary encoder, for example). FIG. 1 illustrates an example case where a laser interferometer is used.

The substrate holder 20 is designed to hold the wafer 60 (the substrate to be processed) in a reference position on the substrate holder 20 with a vacuum chuck, for example. This substrate holder 20 has a moving mechanism (not illustrated) that moves the wafer 60 held by the substrate holder 20 in the horizontal direction (the x-y plane) in a resist application procedure and the pattern transfer procedure.

The wafer position measuring device 21 measures the position of the wafer 60 held by the substrate holder 20. The wafer position measuring device 21 is formed with a position detector such as an interferometer or an encoder (a rotary encoder, for example). FIG. 1 illustrates an example case where a laser interferometer is used.

The resist applying device 30 applies or drops a resist material 61 onto a predetermined position on the wafer 60. The control device 40 performs various kinds of control operations of the pattern forming apparatus. For example, the control device 40 controls the moving mechanisms of the template holder 10 and the substrate holder 20, to move the template 50 and the wafer 60 to desired positions. The control device 40 further performs various kinds of calculating operations. For example, the control device 40 performs a global alignment operation and calculates the later described relative misalignment.

The global alignment operation performed here is an operation to calculate the other shot positions on the wafer, based on the results of the position measurement carried out on part of the mark patterns formed on the wafer 60 prior to the first imprint process.

In this global alignment operation, the control device 40 calculates each shot position on the wafer 60, based on the results of position measurement carried out on predetermined mark patterns, sent from the alignment measuring device 11. The control device 40 then stores the information about each of the calculated shot positions (hereinafter referred to as the alignment information) into a first storage 41.

In the relative misalignment calculation, the control device 40 calculates the relative misalignment from the misalignment of the template 50 and the misalignment of the wafer 60, and stores the relative misalignment as misalignment information into a second storage 42.

This control device 40 includes the first storage 41, the second storage 42, and a third storage 43. The first storage 41 stores the alignment information obtained through the global alignment operation. The second storage 42 stores the misalignment information indicating the relative misalignment between the template 50 and the wafer 60. The third storage 43 stores corrected alignment information that is corrected based on the misalignment information.

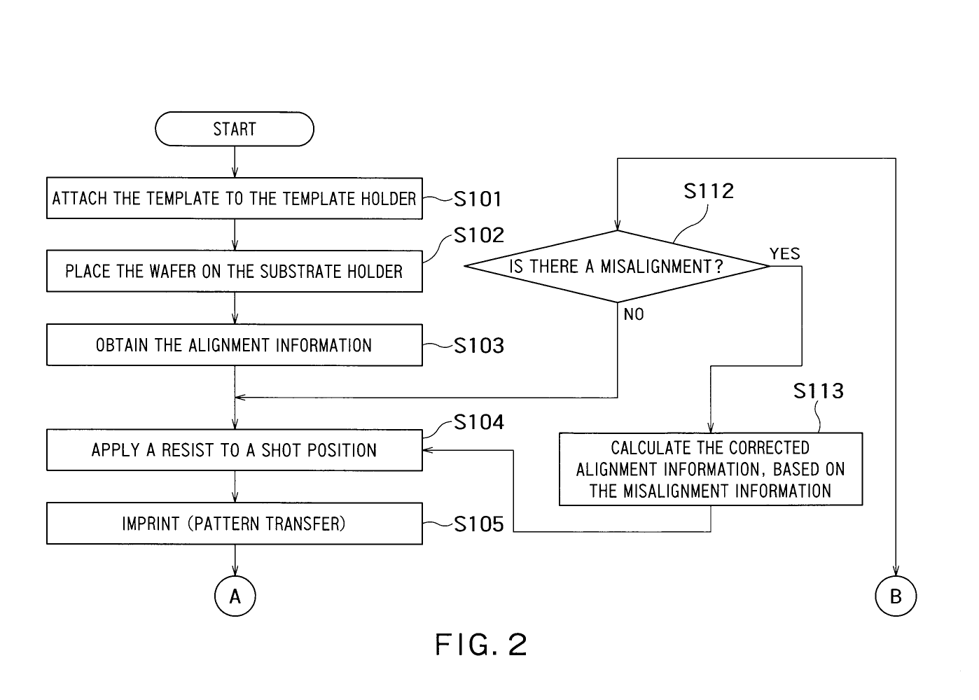

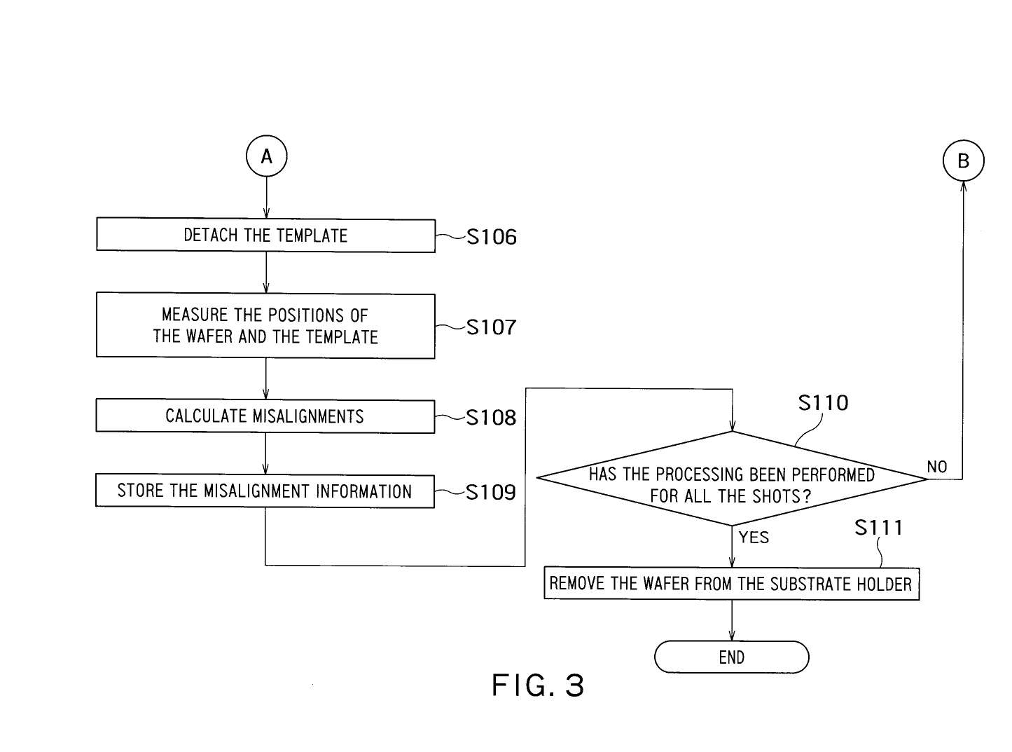

Referring now to the flowcharts illustrated in FIGS. 2 and 3, a pattern forming method according to an optical imprint technique using the above described pattern forming apparatus is described.

(1) The template 50 is attached to the template holder 10 (step S101). To put the template 50 in the reference position on the template holder 10, alignment is performed by measuring the position of the template 50 with the use of the template position measuring device 12, for example.

(2) The wafer 60 is attached to the substrate holder 20 (step S102). To put the wafer 60 in the reference position on the substrate holder 20, alignment is performed by measuring the position of the wafer 60 with the use of the wafer position measuring device 21, for example.

(3) The control device 40 performs the global alignment operation with the use of the alignment measuring device 11, and obtains the alignment information (step S103). This alignment information sets the initial values of the respective shot positions. As mentioned above, the alignment information is stored in the first storage 41.

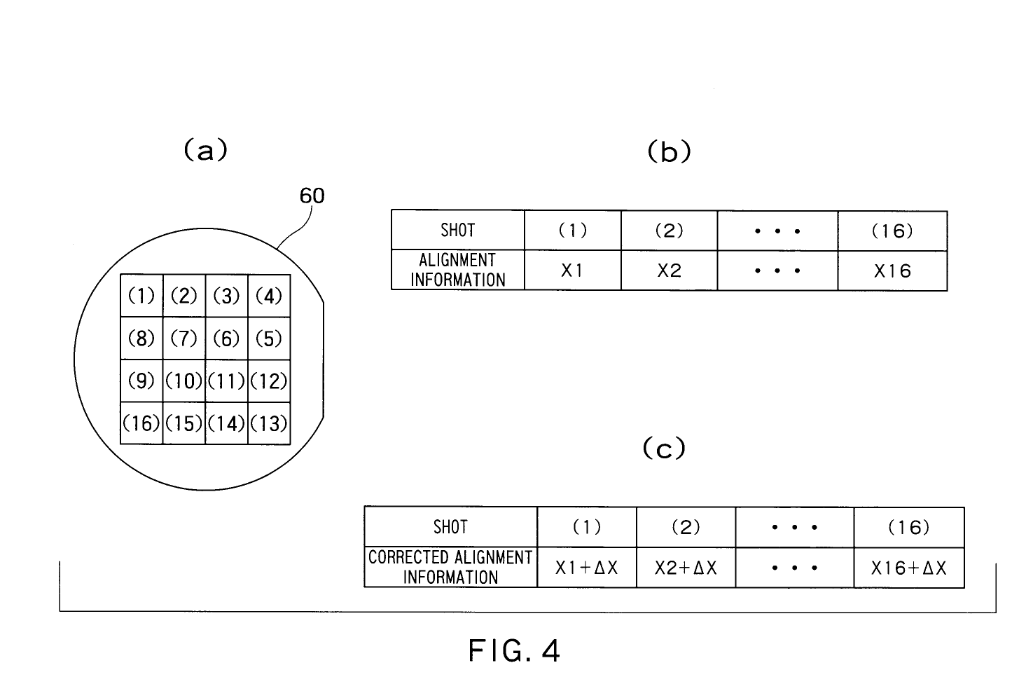

Referring now to FIG. 4, an example of the alignment information stored in the first storage 41 is described. FIG. 4(a) is a plan view of the wafer 60, and illustrates sixteen shot positions on the wafer 60 and the sequence in the imprint process. FIG. 4(b) illustrates the alignment information stored in the first storage 41. As can be seen from this drawing, the alignment information Xi is stored for the shot (i) of the ith (1≦i≦16) imprint process. Accordingly, the alignment information corresponding to the respective shot positions on the wafer 60 is stored in the first storage 41.

(4) The control device 40 then moves the substrate holder 20, and aligns the wafer 60 with the resist applying device 30. After that, the resist applying device 30 applies or drops the resist material 61 onto the shot position to be processed on the wafer 60 (step S104).

(5) The control device 40 then moves the substrate holder 20, and aligns the wafer 60 with the template 50 so that the shot position to be processed comes immediately below the template 50. After that, a pattern transfer is performed (step S105).

The pattern transfer is now described. The template 50 is gradually lowered to approach the resist material 61, and is finally brought into contact with the resist material 61. After the grooves in the concave-convex pattern formed on the surface of the template 50 are filled with the resist material 61, the light (such as UV light) for solidifying the resist material 61 is emitted to solidify the resist material 61. In this manner, a resist pattern having the reverse pattern of the concave-convex pattern of the template 50 is formed on the shot position to be processed.

At steps S104 and S105, the moving of the substrate holder 20 for the alignment is performed with the use of the alignment information stored in the first storage 41 in the first imprint process, and is performed with the use of the corrected alignment information stored in the third storage 43 in the second and later imprint processes. Accordingly, accurate alignment can be performed, even if the template 50 or the wafer 60 is misaligned in the previous imprint process.

(6) The control device 40 then controls the moving mechanism of the template holder 10, to lift the template 50 from the lower resting position to the upper resting position. By doing so, the control device 40 detaches the template 50 from the solidified resist material 61 (step S106) (demolding).

(7) The template position measuring device 12 and the wafer position measuring device 21 then measure the positions of the template 50 and the wafer 60, respectively (step S107). The position measurement of the template 50 is carried out after the template 50 moves upward and returns to the upper resting position, for example.

(8) The control device 40 then calculates the misalignments of the template 50 and the wafer 60, based on the results of the position measurement of step S107 (step S108).

For example, only one direction is considered, for ease of explanation. In that case, the misalignment ΔT is expressed as t1−t0, where t0 represents the position of the template 50 measured at step S101, and t1 represents the position of the template 50 measured after the demolding. Likewise, the misalignment ΔW is expressed as w1−w0, where w0 represents the position of the wafer 60 measured at step S102, and w1 represents the position of the wafer 60 measured after the demolding. In other words, each misalignment is calculated as the distance between the position of the template 50 (the wafer 60) measured prior to the demolding and the position of the template 50 (the wafer 60) measured after the demolding.

(9) The control device 40 then calculates the relative misalignment from the misalignments calculated at step S108, and stores the relative misalignment as the misalignment information into the second storage 42 (step S109).

For example, where only one direction is considered for ease of explanation, the relative misalignment ΔX (=ΔT−ΔW) is determined from the above mentioned misalignments ΔT and ΔW.

(10) A check is then made to determine whether all the imprint processes have been performed on the wafer 60 (step S110).

Where all the imprint processes have been completed, the wafer 60 is removed from the substrate holder 20 (step S111), and the processing of the wafer 60 is finished. Where not all the imprint processes have been performed, the operation moves on to step S112.

The operation flow at steps S112 and the later steps or the operation flow of the second and later imprint processes is now described.

At step S112, a check is made to determine whether there are misalignments detected in the previous imprint process. More specifically, the control device 40 refers to the misalignment information stored in the second storage 42, and determines whether there is a relative misalignment. The control device 40 makes this determination by checking whether the relative misalignment is zero or within a predetermined range, for example.

If the control device 40 determines that there is not a relative misalignment, the operation moves on to step S104. If the control device 40 determines that there is a relative misalignment, the operation moves on to step S113.

At step S113, the control device 40 calculates the corrected alignment information, using the alignment information stored in the first storage 41 and the misalignment information (the relative misalignment) stored in the second storage 42. The control device 40 then stores the corrected alignment information into the third storage 43.

Referring now to FIG. 4, an example of the corrected alignment information stored in the third storage 43 is described. FIG. 4(c) illustrates the corrected alignment information stored in the third storage 43. Here, ΔX represents the misalignment information stored in the second storage 42, which is the relative misalignment between the template 50 and the wafer 60. As can be seen from this drawing, the third storage 43 stores the corrected alignment information Xi+ΔX about the shot (i) of the ith imprint process (1≦i≦16).

In the last imprint process for the wafer 60 (the shot (16) in the example illustrated in FIG. 4), the steps S107 through S109 may not be carried out.

Although misalignments only in one direction are considered in the above description of the misalignment calculation for ease of explanation, relative misalignments can be calculated in the same manner in any other cases. For example, in the case of two directions (the x-y plane), the misalignments of the template and the wafer in the x-direction and in the y-direction are calculated. As a result of this, the misalignment vector (t₁ₓ−t₀ₓ, t_{1y}−t_{0y}) of the template and the misalignment vector (w₁ₓ−w₀ₓ, w_{1y}−w_{0y}) of the wafer are determined. Here, the position of the template 50 measured at step S101 is represented by (t_{0y}, t_{0y}), the position of the wafer 60 measured at step S102 is represented by (w₀ₖ, w_{0y}), the position of the template 50 measured after the demolding is represented by (t₁ₓ, t_{1y}), and the position of the wafer 60 measured after the demolding is represented by (w₁ₓ, w_{1y}). By calculating the difference in misalignment vector between the template 50 and the wafer 60, the relative misalignment vector as the above described relative misalignment can be determined.

As described above, in this embodiment, the global alignment method that can dramatically shortens the period of time required for the alignment process is utilized, and the positions of the template and the wafer are measured after demolding. The relative misalignment (the misalignment of the template relative to the wafer) is then calculated. If there is a relative misalignment, the alignment information corrected with the use of the misalignment information indicating the relative misalignment is calculated (the corrected alignment information). In the next imprint process, alignment between the wafer and the template is performed with the use of the corrected alignment information.

Accordingly, even if misalignments of the wafer and the template are caused due to the demolding procedure, the wafer and the template can be accurately aligned with each other.

The “demolding procedure” of the present invention includes at least the following procedure D, but may also be regarded as a series of procedures that start with the following procedure A, B, or C, and ends with the procedure D or E.

Procedure A: The template 50 is lowered toward the resist material 61;

Procedure B: The template 50 is brought into contact with the resist material 61;

Procedure C: The resist material 61 is solidified;

Procedure D: The template 50 is detached from the solidified resist material 61; and

Procedure E: the template 50 is lifted to the upper resting position.

As described above, in accordance with this embodiment, a pattern can be formed by imprinting, without a throughput decrease and deterioration of alignment precision. As a result, yield deterioration is prevented, and the costs of semiconductor devices can be lowered.

A modification of this embodiment will now be described.

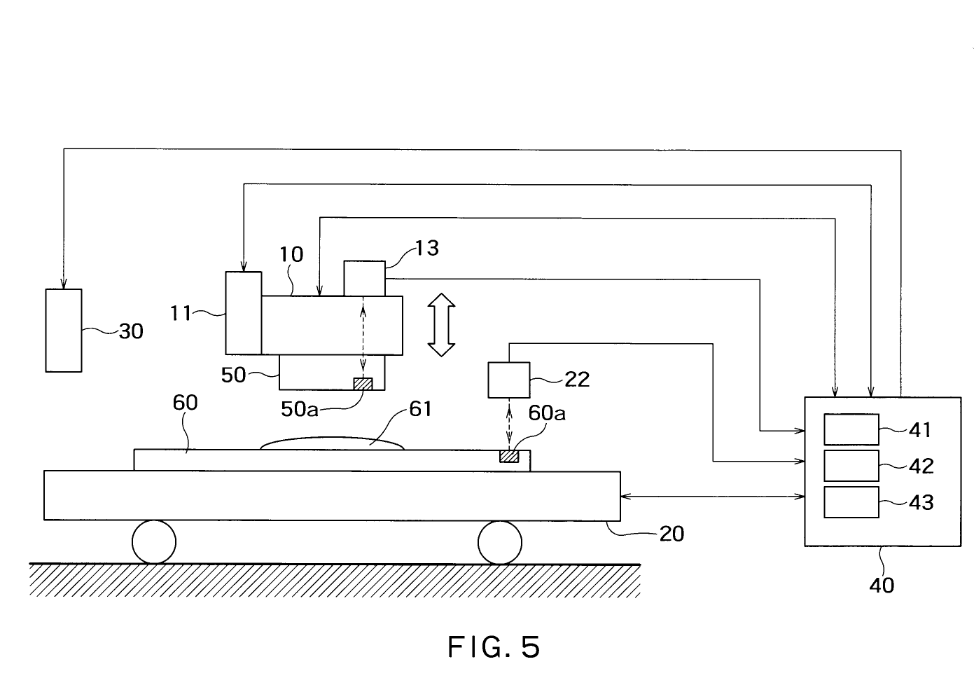

FIG. 5 schematically illustrates the structure of a pattern forming apparatus according to a modification. One of the differences between this modification and the first embodiment lies in the template position measuring device and the wafer position measuring device. As illustrated in FIG. 5, the template position measuring device 13 according to this modification measures the position of an alignment mark 50a formed on the template 50, and the wafer position measuring device 22 measures the position of an alignment mark 60a formed on the wafer 60.

In this modification, misalignments of the template 50 and the wafer 60 are measured in the following manner. A misalignment of the template 50 can be determined by measuring the fluctuation of the position of the alignment mark 50a of the template 50 with respect to a holder mark indicating the reference position formed on the template holder 10. Likewise, a misalignment of the wafer 60 can be determined by measuring the fluctuation of the position of the alignment mark 60a of the wafer 60 with respect to a mark indicating the reference position formed on the substrate holder 20.

Alternatively, a position measuring device according to this modification and a position measuring device according the above described embodiment may be combined to form a pattern forming apparatus. For example, the template position measuring device 12 according to the first embodiment may be used to measure the position of the template, while the wafer position measuring device 22 according to this modification is used to measure the position of the wafer.

In the above described embodiment, the optical imprint technique is utilized. However, the present invention is not limited to that, and any other imprint technique may be utilized. For example, a thermal imprint technique may be utilized in the following manner. At step S104, the resist applying device 30 applies a thermoplastic resist to the wafer 60. At step S105, after the applied resist is softened by heating the wafer 60, the template 50 is brought into contact with the resist and is pressed (pushed) against the resist, to deform the resist. After that, the wafer 60 is cooled, to solidify the resist.

Also, in the above described embodiment, the application procedure is carried out in each imprint process, and the resist material 61 is applied to each shot position. However, the present invention is not limited to that, and the resist material 61 may be applied to the entire wafer 60 prior to the first imprint process. More specifically, after step S103, for example, the resist material 61 may be applied to the entire wafer 60 by a spin coating technique or the like. This technique is suitable particularly in a case where a thermal imprint technique is utilized. In such a case, step S104 can be skipped in each imprint process, the throughput can be increased.

Also, in the above described embodiment, a check is made to determine whether there is a misalignment caused in the previous imprint process at step S112. However, the present invention is not limited to that, and step S112 may be skipped. Regardless of whether there is a misalignment, the corrected alignment information may be calculated, and the corrected alignment information stored in the third storage 43 may be updated. In such a case, step S113 for calculating the corrected alignment information may be carried out between step S110 and step S104, or between step S109 and step S110.

Also, in the above described embodiment, the corrected alignment information calculated at step S113 is stored into the third storage 43. However, the present invention is not limited to that. The alignment information may be overwritten, to store the corrected alignment information into the first storage 41. In such a case, the moving of the substrate holder 20 at steps S104 and S105 should be performed always with the use of the information stored in the first storage 41.

Also, in the above described embodiment, the first storage 41, the second storage 42, and the third storage 43 are provided inside the control device 40. However, the present invention is not limited to that. Those storages may be provided outside the control device 40, and the control device 40 may access the external storages.

Also, in the above described embodiment, at step S108, misalignments of the template 50 and the wafer 60 are calculated as displacements from the reference positions measured at steps S101 and S102, respectively. However, the present invention is not limited to that, and misalignments may be measured before and after the demolding procedure in each imprint process.

More specifically, the misalignment of the wafer 60 may be determined from the difference between the positions of the wafer 60 measured before and after the template 50 is detached from the solidified resist material 61. Likewise, the misalignment of the template 50 may be determined from the difference between the positions of the template 50 measured before and after the template 50 is detached from the solidified resist material 61.

For example, the misalignment of the template 50 is determined from the difference between the position of the template 50 measured when the template 50 is located in the upper resting position prior to the demolding procedure, and the position of the template 50 measured when the template 50 returns from the lower resting position to the upper resting position after the remolding procedure.

Where misalignments are determined before and after the demolding procedure, Δx (=Δt−Δw) is added to the misalignment information ΔX stored in the second storage 42, with Δt representing the misalignment of the template 50 measured before and after the demolding procedure, Δx representing the misalignment of the wafer 60 measured before and after the demolding procedure. Accordingly, after step S109, ΔX+Δx is stored as the misalignment information into the second storage 42.

Also, in the above described embodiment, the template position measuring device 12 and the wafer position measuring device 21 are both used as devices that measure misalignments. However, the present invention is not limited to that. For example, in a case where one of the misalignments of the template and the wafer is so small as to be ignorable, compared with the other one, the position measuring device for measuring the ignorable misalignment may be removed. In such a case, the misalignment (the above described ΔT or ΔW, for example) measured by the remaining one of the template position measuring device 12 and the wafer position measuring device 21 is stored as the relative misalignment (the above mentioned ΔX, for example) into the second storage 42.

Also, in the above described embodiment, the substrate holder 20 is designed to move in a horizontal plane (the x-y plane), and the template holder 10 is designed to move in the vertical direction (the z-direction). However, the template holder 10 may be designed to move in the horizontal plane, while the substrate holder 20 is designed to move in the vertical direction.

Further, a moving mechanism that is capable of moving the template 50 in the horizontal plane as well as in the vertical direction may be provided in the template holder 10.

Also, in the above described embodiment, the initial value of each shot position is obtained by performing a global alignment operation. However, the initial value may be obtained by any technique other than the global alignment method. Alternatively, if the wafer 60 can be attached to the substrate holder 20 with sufficient precision, the operation to obtain the initial value of each shot position may not be performed, and given information about each shot position may be used instead.

Additional advantages and modifications will readily occur to those skilled in the art.

Therefore, the invention in its broader aspects is not limited to the specific details and representative embodiments shown and described herein.

Accordingly, various modifications may be made without de parting from the spirit or scope of the general inventive concepts as defined by the appended claims and their equivalents.

What is claimed is:

1. A pattern forming apparatus that forms a pattern by an imprint technique, comprising:
a substrate holder that is configured to be capable of holding a substrate to be processed;
a template holder that is configured to be capable of holding a template that has a pattern face, a predetermined pattern being formed on the pattern face;
a first position measuring device that measures a position of the substrate to be processed held by the template holder;
a second position measuring device that measures a position of the template held by the template holder; and
a control device that aligns the substrate to be processed and the template with each other, based on transfer position information indicating a position on the substrate to be processed, the predetermined pattern being transferred to the position, calculates a misalignment of the substrate to be processed caused by a demolding procedure, based on a result of the measurement carried out by the first position measuring device, the demolding procedure being carried out to detach the template from a solidified resist material on the substrate to be processed, calculates a misalignment of the template caused by the demolding procedure, based on a result of the measurement carried out by the second position measuring device, calculates a relative misalignment between the substrate to be processed and the template, based on the misalignment of the substrate to be processed and the misalignment of the template, and corrects the transfer position information, using the relative misalignment.

2. The pattern forming apparatus according to claim 1, wherein
the control device obtains the transfer position information by performing a global alignment operation, positions of part of a plurality of alignment marks formed on the substrate to be processed being measured in advance in the global alignment operation, positions of the other ones of the alignment marks being calculated based on a result of the measurement in the global alignment operation.

3. The pattern forming apparatus according to claim 2, wherein
the first position measuring device is configured to measure a first position of the substrate to be processed prior to the demolding procedure, and measure a second position of the substrate to be processed after the demolding procedure,
the second position measuring device is configured to measure a first position of the template when the template is located in an upper resting position, and measure a second position of the template after the demolding procedure is carried out and the template returns to the upper resting position, the upper resting position being an upper position where the substrate to be processed stops when the substrate to be processed moves up and down, and
the control device is configured to calculate a distance between the first position of the substrate to be processed and the second position of the substrate to be processed, set the distance as the misalignment of the substrate to be processed, calculate a distance between the first position of the template and the second position of the template, and set the distance as the misalignment of the template.

4. The pattern forming apparatus according to claim 3, wherein
the first position measuring device and/or the second position measuring device is formed with a laser interferometer or an encoder.

5. The pattern forming apparatus according to claim 2, wherein
the first position measuring device is configured to measure a position of an alignment mark of the substrate to be processed, and
the control device is configured to calculate a fluctuation of the position of the alignment mark of the substrate to be processed with respect to a mark indicating a reference position formed on the substrate holder, and set the fluctuation as the misalignment of the substrate to be processed.

6. The pattern forming apparatus according to claim 2, wherein
the second position measuring device is configured to measure a position of an alignment mark of the template, and
the control device is configured to calculate a fluctuation of the position of the alignment mark of the template with respect to a mark indicating a reference position formed on the template holder, and set the fluctuation as the misalignment of the template.

7. The pattern forming apparatus according to claim 1, wherein
the first position measuring device is configured to measure a first position of the substrate to be processed prior to the demolding procedure, and measure a second position of the substrate to be processed after the demolding procedure,
the second position measuring device is configured to measure a first position of the template when the template is located in an upper resting position, and measure a second position of the template after the demolding procedure is carried out and the template returns to the upper resting position, the upper resting position being an upper position where the substrate to be processed stops when the substrate to be processed moves up and down, and
the control device is configured to calculate a distance between the first position of the substrate to be processed and the second position of the substrate to be processed, set the distance as the misalignment of the substrate to be processed, calculate a distance between the first position of the template and the second position of the template, and set the distance as the misalignment of the template.

8. The pattern forming apparatus according to claim 7, wherein
the first position measuring device and/or the second position measuring device is formed with a laser interferometer or an encoder.

9. The pattern forming apparatus according to claim 1, wherein
the first position measuring device is configured to measure a position of an alignment mark of the substrate to be processed, and
the control device is configured to calculate a fluctuation of the position of the alignment mark of the substrate to be processed with respect to a mark indicating a reference position formed on the substrate holder, and set the fluctuation as the misalignment of the substrate to be processed.

10. The pattern forming apparatus according to claim 1, wherein
the second position measuring device is configured to measure a position of an alignment mark of the template, and
the control device is configured to calculate a fluctuation of the position of the alignment mark of the template with respect to a mark indicating a reference position formed on the template holder, and set the fluctuation as the misalignment of the template.

11. The pattern forming apparatus according to claim 1, further comprising
a resist applying device that applies or drops a resist material onto a predetermined position on the substrate to be processed.

12. A pattern forming apparatus that forms a pattern by an imprint technique, comprising:
a substrate holder that is configured to be capable of holding a substrate to be processed;
a template holder that is configured to be capable of holding a template that has a pattern face, a predetermined pattern being formed on the pattern face;
a position measuring device that measures a position of the substrate to be processed held by the substrate holder, or a position of the template held by the template holder; and
a control device that aligns the substrate to be processed and the template with each other, based on transfer position information indicating a position on the substrate to be processed, the predetermined pattern being transferred to the position, calculates a misalignment of the substrate to be processed or the template caused by a demolding procedure, based on a result of the measurement carried out by the position measuring device, the demolding procedure being carried out to detach the template from a solidified resist material on the substrate to be processed, and corrects the transfer position information, using the misalignment as a relative misalignment between the substrate to be processed and the template.

13. The pattern forming apparatus according to claim 12, wherein
the control device obtains the transfer position information by performing a global alignment operation, positions of part of a plurality of alignment marks formed on the substrate to be processed being measured in advance in the global alignment operation, positions of the other ones of the alignment marks being calculated based on a result of the measurement in the global alignment operation.

14. The pattern forming apparatus according to claim 12, wherein
the position measuring device is configured to measure a first position of the substrate to be processed prior to the demolding procedure and measure a second position of the substrate to be processed after the demolding procedure, and the control device is configured to calculate a distance between the first position of the substrate to be processed and the second position of the substrate to be processed, and set the distance as the misalignment of the substrate to be processed, or
the position measuring device is configured to measure a first position of the template when the template is located in an upper resting position and measure a second position of the template after the demolding procedure is carried out and the template returns to the upper resting position, the upper resting position being an upper position where the substrate to be processed stops when the substrate to be processed moves up and down, and the control device is configured to calculate a distance between the first position of the template and the second position of the template, and set the distance as the misalignment of the template.

15. The pattern forming apparatus according to claim 14, wherein
the position measuring device is formed with a laser interferometer or an encoder.

16. The pattern forming apparatus according to claim 12, wherein
the position measuring device is configured to measure a position of an alignment mark of the substrate to be processed, and the control device is configured to calculate a fluctuation of the position of the alignment mark of the substrate to be processed with respect to a mark indicating a reference position formed on the substrate holder, and set the fluctuation as the misalignment of the substrate to be processed, or
the position measuring device is configured to measure a position of an alignment mark of the template, and the control device is configured to calculate a fluctuation of the position of the alignment mark of the template with respect to a mark indicating a reference position formed on the template holder, and set the fluctuation as the misalignment of the template.

17. A pattern forming method for forming a pattern by an imprint technique,
the pattern forming method comprising:
holding a substrate to be processed in a reference position on a substrate holder;
holding a template in a reference position on a template holder, the template having a pattern face, a predetermined pattern being formed on the pattern face;
obtaining transfer position information indicating a position on the substrate to be processed, the predetermined pattern being transferred onto the position;
applying or dropping a resist material onto the substrate to be processed;
aligning the substrate to be processed and the template with each other, based on the transfer position information;
solidifying the resist material after the template is brought into contact with the resist material and grooves of the predetermined pattern on the template are filled with the resist material;
carrying out a demolding procedure to detach the template from the solidified resist material on the substrate to be processed;
measuring a position of the substrate to be processed and a position of the template after the demolding procedure, and calculating a misalignment of the substrate to be processed and a misalignment of the template, based on results of the measurement, the misalignments being caused by the demolding procedure;
calculating a relative misalignment between the substrate to be processed and the template, based on the misalignment of the substrate to be processed and the misalignment of the template; and
correcting the transfer position information, using the relative misalignment.

18. The pattern forming method according to claim 17, wherein
the transfer position information is obtained by performing a global alignment operation, positions of part of a plurality of alignment marks formed on the substrate to be processed being measured in advance in the global alignment operation, positions of the other ones of the alignment marks being calculated based on a result of the measurement in the global alignment operation.

19. The pattern forming method according to claim 17, wherein
the misalignment of the substrate to be processed is calculated as a distance between the reference position on the substrate holder or a position of the substrate to be processed measured after the demolding procedure in a previous imprint process and a position of the substrate to be processed measured after the demolding procedure; and
the misalignment of the template is calculated as a distance between the reference position on the template holder or a position of the template measured after the demolding procedure in the previous imprint process and a position of the template measured after the demolding procedure.

20. The pattern forming method according to claim 17, wherein
the misalignment of the substrate to be processed is calculated from a fluctuation of a position of an alignment mark formed on the substrate to be processed with respect to a mark formed on the substrate holder, the mark indicating the reference position on the substrate holder, and
the misalignment of the template is calculated from a fluctuation of a position of an alignment mark formed on the template with respect to a mark formed on the template holder, the mark indicating the reference position on the template holder.
